(19) United States
(12) Patent Application Publication
(10) Pub. No.: US 2006/0175568 A1
(43) Pub. Date: Aug. 10, 2006

(54) Electrically actuated valve arrangement

(76) Inventors: Andreas Grundl, Munchen (DE); Bernhard Hoffmann, Starnberg (DE)

Correspondence Address: WOOD, HERRON & EVANS, LLP, 2700 CAREW TOWER, 441 VINE STREET, CINCINNATI, OH, 45202, US

(21) Appl. No.: 10/544,134

(22) PCT Filed: Jan. 23, 2004
(86) PCT No.: PCT/EP04/00568

§ 371 Date: Apr. 18, 2006

(30) Foreign Application Priority Data
Jan. 29, 2003 (DE) 103 03 426.9

(51) Int. Cl. F16K 31/44

(52) U.S. Cl. 251/215

(57) ABSTRACT

An electrically actuated valve arrangement for the controlled opening and closing of a working chamber of an internal-combustion engine, with an electrical linear drive unit which, depending on electrical triggering signals, causes a valve stem of the valve arrangement to execute longitudinal movements between an open position and a closed position of the valve arrangement, with at least one actuating element and an engagement element interacting with said actuating element, one of these elements being arranged in torsion-resistant manner on the valve stem and the other of these elements being arranged statically in relation to the mobile valve stem in such a manner that prior to reaching the open or closed position of the valve stem the engagement element and the actuating element come into engagement with one another and trigger a rotary movement which is superimposed on the longitudinal movement of the valve stem.

### BACKGROUND OF THE INVENTION

The invention relates to an electrically actuated valve arrangement for the controlled opening and closing of a working chamber of an internal-combustion engine, according to the generic portion of Claim 1.

In WO 02/08579 A1 a valve arrangement is described, on the valve stem of which a valve-closing member in the form of a disc or a needle or such like is fastened which interacts with a correspondingly shaped valve seat, in order to bring about the opening or closing of the valve arrangement. With seat valves of such a type in internal-combustion engines there is the problem that a non-uniform wear of the valve-closing member or of the valve seat may occur. In conventional valve arrangements, care is taken to ensure that the valve stem, and with it the valve-closing member, executes a small rotary movement with each stroke by virtue of a slightly asymmetrical application of force onto the valve stem with the aid of the cams of the camshaft of the internal-combustion engine. Hence the valve-closing member and the valve seat always come into closing contact in a slightly rotationally offset position.

From the generic state of the art according to JP 09-151716 A a valve arrangement is known in which changes of dimension of the valve stem, for example by reason of thermal influences, are to be compensated. To this end, the valve stem is formed with a disc that is provided with ramp profiles which interact with complementary ramp profiles, whereby in the case of thermal changes of dimension of the valve stem a displacement of the two ramp profiles with respect to one another occurs until the valve element fits tightly with a valve seat and furthermore the two ramp profiles fit tightly with one another. This valve arrangement provides, if need be, for a rotation of the valve element in the case where the dimensions of the valve stem have changed. However, if the valve stem is not subject to a change of dimension, the rotary position of the valve element remains unchanged with each stroke.

Furthermore, a valve-rotating device with a relatively elaborate and space-claiming lever arrangement is known from DD 123 688 A.

### PROBLEM UNDERLYING THE INVENTION

With new types of internal-combustion engine, the valve stems of which are not actuated by means of cams of a camshaft but are caused to open and close the valve arrangement via a linear drive unit, there is the problem that linear drive units of such a type are ordinarily unable to cause the valve stem to execute a rotary movement. The present invention has the aim of eliminating this disadvantage.

### SOLUTION ACCORDING TO THE INVENTION

The invention solves this problem with a valve arrangement having the features of Claim 1.

This configuration ensures that the valve-closing member executes a small rotary movement in relation to the valve seat with each stroke in a manner analogous to that in the case of conventional valves of internal-combustion engines, so that a non-uniform wear of the valve-closing member or of the valve seat, but also of the guideway of the valve stem, is avoided.

### ADVANTAGEOUS CONFIGURATION OF THE INVENTION

In a first configuration of the invention, the engagement element is connected to the valve stem and the actuating element is arranged on the housing of the working chamber. As an alternative to this, the engagement element may also be arranged on the housing of the working chamber. In this case the actuating element is connected to the valve stem. In particular if a variant with low mass is chosen for the configuration of the actuating element, the remaining functional characteristics of the valve (mass to be moved, impairment of the flow of fluid, to the extent that the respective element is located in the flow of fluid controlled by the valve arrangement, etc.) are changed only slightly or not at all.

The engagement element may be an area or plate provided with surface irregularities.

The engagement element may also be a disc or a surface segment that has substantially radially oriented depressions and/or elevations relative to the central longitudinal axis of the valve stem.

In a preferred embodiment the actuating element is a spring arrangement, in particular a leaf-spring arrangement, which has a substantially tangential directional component relative to the central longitudinal axis of the valve stem. The actuating element may be arranged at an acute angle (90°) [sic] relative to an active surface of the engagement element.

Instead of a yielding actuating element, for example a spring arrangement, the engagement element may also be designed in the form of a plate, disc or surface segment that is resiliently yielding in the direction of the longitudinal movement of the valve stem. In this case the actuating element is substantially rigid and arranged at an acute angle to the engagement element with a substantially tangential directional component relative to the central longitudinal axis of the valve stem.

The rotary movement is preferably imparted to the valve stem in the course of the approach to the open position of the valve arrangement. This has the advantage that no chafing rotary movement occurs between the valve-closing member and the valve seat when the valve arrangement assumes its closed position.

Further advantages, configurations or possibilities for variation will become apparent from the following description of the Figures, in which the invention is described in detail.

### BRIEF DESCRIPTION OF THE FIGURES

FIG. 1 shows a schematic representation in longitudinal section through a valve arrangement according to the invention;

FIG. 2 shows a schematic top view of a cross-section through FIG. 1, along line II-II.

### DETAILED DESCRIPTION OF THE FIGURES

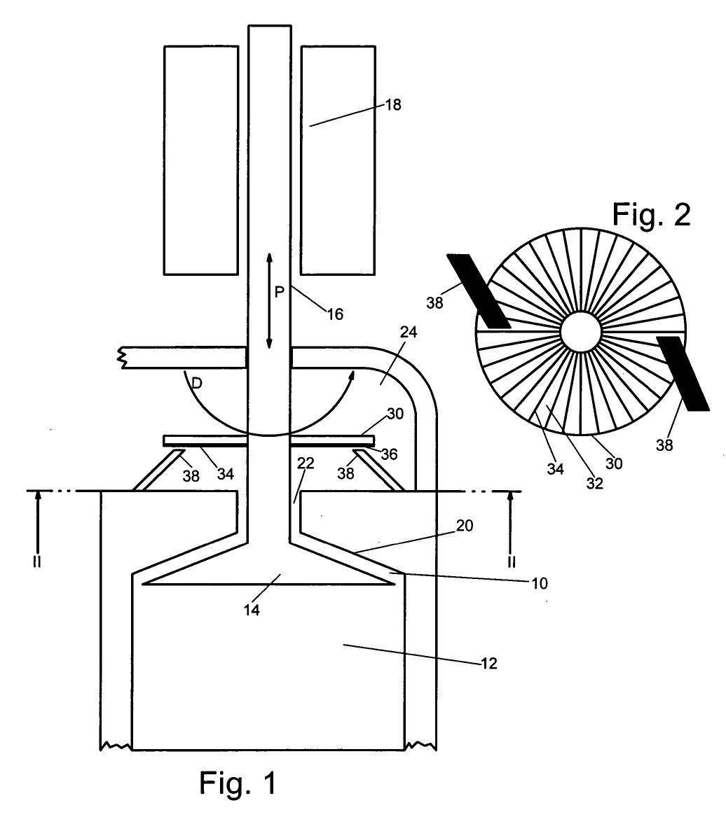

An electrically actuated valve arrangement 10 for the controlled opening and closing of a working chamber 12 of an internal-combustion engine which is not illustrated in any detail is shown in FIG. 1. The valve arrangement 10 has a valve-closing member 14 which in this embodiment is disc-shaped and which is connected in torsion-resistant manner to a rod-shaped valve stem 16. The valve stem 16 is radially coupled to an electrical linear drive unit 18 which is not illustrated in detail and which, depending on electrical triggering signals from an electronic control unit, brings the valve stem 16, and hence the valve-closing member 14 which is rigidly connected to said valve stem, in the direction of the arrow P into the open position shown in FIG. 1 or into a closed position in which the valve-closing member rests in close contact with a valve seat 20. In the closed position of the valve arrangement 10 no fluid from the working chamber 12 of the internal-combustion engine is able to flow between the valve-closing member 14 and the valve seat 20 out of a fluid duct 24 via an annular gap 22 surrounding the valve stem 16, or in the opposite direction into the working chamber 12.

A rigid disc 30 is arranged on the valve stem 16 in torsion-resistant manner. On its side facing towards the valve-closing member 14 this rigid disc 30 has elevations 32 and depressions 34 which constitute radially oriented surface irregularities relative to the midpoint of the disc 30.

The disc 30 constitutes an engagement element which, together with actuating elements 38 described below, causes the valve stem 16 to execute, in addition to its movement in the longitudinal direction of the arrow P, also a controlled rotary movement in the direction of the arrow D.

The actuating elements 38 are constituted by elongated leaf-spring arrangements which are each fastened by one end to the outside of the housing of the working chamber 12 and which, with their respective free end, come into engagement with an active surface 36 of the disc 30 if the valve stem 16 moves in the direction of the arrow P from the closed position into the open position of the valve arrangement 10. The actuating elements 38 are oriented at an acute angle of approximately 45° relative to the active surface 36 of the engagement element 30 and have a tangential directional component with respect to the disc-shaped engagement element 30.

In operation of the valve arrangement, the free ends of the actuating elements 38 which are provided in the form of leaf springs come into engagement with the elevations or depressions 32, 34 of the active surface 36 of the engagement element 30 if the disc 30 moves along the arrow P in the direction towards the actuating elements 38. In the process, the inclined leaf springs 38 are pushed down, and the free ends thereof, which are in engagement with the depressions/elevations 32, 34 of the disc 30, bring about a rotation in the circumferential direction of the disc 30. In this way it is ensured that the valve-closing member 14 and the valve seat 20 assume a new position with respect to one another with each closing of the valve arrangement.

1. An electronically actuated valve arrangement (10) for the controlled opening and closing of a working chamber (12) of an internal-combustion engine, with
an electrical linear drive unit (18) which, depending on electrical triggering signals, causes a valve stem (16) of the valve arrangement (10) to execute longitudinal movements between an open position and a closed position of the valve arrangement (10), characterised by
at least one actuating element (38) and an engagement element (30) interacting with said actuating element, one of these elements being arranged in torsion-resistant manner on the valve stem and the other of these elements being arranged statically in relation to the mobile valve stem (16) in such a manner that
prior to reaching the open or closed position of the valve stem (16) the engagement element (30) and the actuating element (38) come into engagement with one another and trigger a rotary movement (D) which is superimposed on the longitudinal movement (P) of the valve stem (16).

2. Electrically actuated valve arrangement (10) according to claim 1, wherein the engagement element (30) is connected to the valve stem (16) and the actuating element (38) is arranged on the housing of the working chamber (12).

3. Electrically actuated valve arrangement (10) according to claim 1, wherein the engagement element (30) is arranged on the housing of the working chamber (12) and the actuating element (38) is connected to the valve stem (16).

4. Electrically actuated valve arrangement (10) according to claim 1, wherein the engagement element (30) is an area or plate provided with surface irregularities.

5. Electrically actuated valve arrangement (10) according to claim 4, wherein the engagement element (30) is a disc or a surface segment with substantially radially oriented depressions and/or elevations (32, 34) relative to the valve stem (16).

6. Electrically actuated valve arrangement (10) according to claim 1, wherein the actuating element (38) is a spring arrangement with a substantially tangential directional component relative to the valve stem (16).

7. Electrically actuated valve arrangement (10) according to claim 1, wherein the actuating element (38) is oriented at an acute angle relative to an active surface (36) of the engagement element (30).

8. Electrically actuated valve arrangement (10) according to claim 1, wherein the rotary movement (D) is imparted to the valve stem (16) in the course of the approach to the open position.
